(19) United States
(12) Patent Application Publication
(10) Pub. No.: US 2025/0279726 A1
(43) Pub. Date: Sep. 4, 2025

(54) ELECTROLYSIS PLANT AND PLANT NETWORK COMPRISING AN ELECTROLYSIS PLANT AND A RENEWABLE ENERGY PLANT

(71) Applicant: Siemens Energy Global GmbH & Co. KG, München (DE)

(72) Inventor: Sven Schumann, Wilhermsdorf (DE)

(21) Appl. No.: 18/862,634

(22) PCT Filed: Jan. 20, 2023
(86) PCT No.: PCT/EP2023/051411

§ 371 Date: Nov. 4, 2024

(30) Foreign Application Priority Data
May 4, 2022 (DE) 10 2022 204 402.9

(51) Int. Cl. H02M 3/335

(52) U.S. Cl. CPC H02M 3/335

(57) ABSTRACT

An electrolysis plant includes an electrolyzer and a circuit assembly which has an input for connecting to an external DC source and an output connected to the electrolyzer. The circuit assembly has a transformer with an inverter connected on the primary side and a rectifier connected on the secondary side, such that a direct current can be supplied to the electrolyzer. There is also described a plant network with a electrolysis plant and a renewable energy plant that is directly connected to the electrolysis plant.

The invention relates to an electrolysis plant comprising an electrolyzer and a circuit arrangement. The invention also relates to a plant network comprising an electrolysis plant and a renewable energy plant connected to the electrolysis plant.

An electrolysis plant is an apparatus that brings about a conversion of substances with the aid of electrical current (electrolysis). In accordance with the variety of different electrochemical electrolysis processes, there are also a multiplicity of electrolysis plants, for example an electrolysis plant for water electrolysis.

Hydrogen is nowadays produced, for example, from water by means of Proton Exchange Membrane (PEM) electrolysis or alkaline electrolysis. The electrolysis plants produce hydrogen and oxygen from the supplied water with the aid of electrical energy. This process takes place in an electrolysis stack composed of a plurality of electrolysis cells. In the electrolysis stack that is under a DC voltage, water is introduced as the educt, wherein, after passing through the electrolysis cells, two fluid flows consisting of water and gas bubbles (O₂ or H₂) emerge.

Current considerations include producing valuable substances using excess energy from renewable energy sources in times when there is a lot of sun and a lot of wind, that is to say above-average solar power or wind power production. A valuable substance may be, in particular, hydrogen which is produced by water electrolysis plants. So-called renewable energy gas—also referred to as RE gas—can be produced on the basis of hydrogen, for example. An RE gas is a combustible gas which is obtained from renewable sources with the aid of electrical energy.

Hydrogen is a particularly environmentally friendly and sustainable energy carrier. It has the unique potential to implement energy systems, traffic and large parts of the chemical industry without CO₂ emissions. However, to achieve this, the hydrogen must not come from fossil sources, but rather must be produced with the aid of renewable energy. In the meantime, at least a growing proportion of the power produced from renewable sources has been fed into the public power grid. Therefore, according to the power mix, a corresponding proportion of green hydrogen can be produced if an electrolysis plant is operated with power from the public grid.

In the case of electrolysis processes carried out on an industrial scale, the direct current is predominantly provided via line-commutated rectifiers. During this rectification of a grid-side AC voltage, the method of operation of the rectifiers may result in harmonics which can load the AC grid and/or the DC grid.

EP 3 723 254 A1 discloses such an electrolysis plant that is connected to the public power grid and is accordingly fed with grid power. For this purpose, the electrolysis plant has a circuit arrangement comprising four coil arrangements and four rectifiers. The first coils of the coil arrangements are each connected to the DC voltage side of one of the rectifiers. The circuit arrangement also comprises two transformers each having a primary winding and two secondary windings. The primary windings of the transformers are connected to the power grid, for example a medium-voltage grid or a high-voltage grid. This makes it possible to carry out desired smoothing of the direct current, or the attenuation of the harmonics, despite the reduced iron content within the first coil.

A source of renewable energies results from the increasing use of wind power. In particular, so-called offshore wind energy plants can be used to achieve high electrical powers. However, the challenge is that it is necessary to overcome a large distance to the consumers. The energy should therefore be transported to the consumer with as little loss as possible. Hydrogen is very suitable as a transport medium and energy carrier. It can be transported through pipelines in gaseous form, for example. A positive secondary aspect here is that a hydrogen-carrying pipeline can perform the function of an energy store at the same time since the internal pressure can be varied within certain limits.

From these considerations, it is of particular economic interest to produce the hydrogen directly at the energy production location, that is to say autonomously and independently of the public grid. For this purpose, it is proposed to install the electrolysis plants on offshore platforms in the maritime sector directly at offshore wind energy plants or in the immediate vicinity of the latter and to electrically supply them with the power produced.

Concepts for using the power from onshore wind power plants or photovoltaic plants to directly produce hydrogen at least partially by means of a direct connection to and feeding into an electrolysis plant have also been proposed for dry land. In all of these applications, the electrolysis plant is part of an island grid. The electrolysis current is therefore not obtained from the public grid, but rather is supplied directly by a wind energy plant or a PV plant and is fed into an electrolyzer of the electrolysis plant. It may still be possible to buffer the electrical energy produced by a wind energy plant or a PV plant in a battery, for example. In contrast to the line-commutated operation described above, this respectively entails special challenges and problems in terms of the electrotechnical attachment and connection of the electrolysis plant to the respective RE production plant, whether a wind energy plant or a photovoltaic plant, in particular in order to ensure safe and, in particular, interference-free operation of the electrolysis plant in a direct plant network having the RE production plant.

The invention is therefore based on the object of specifying an electrolysis plant that can be used to feed power from a renewable source into the electrolysis plant directly and without interference.

This object is achieved, according to the invention, by means of an electrolysis plant comprising an electrolyzer and a circuit arrangement having an input for connection to an external DC source and an output connected to the electrolyzer, wherein the circuit arrangement has a transformer, to which an inverter is connected on the primary side and a rectifier is connected on the secondary side, with the result that a direct current can be supplied to the electrolyzer.

The invention is already based on the knowledge that electrolysis plants, in particular the PEM water electrolysis cells of the electrolyzer, are very sensitive to high-frequency electrical stray currents. These stray currents can be coupled into the electrolysis plant via ground connections or ground faults. As a result of necessary plant parts such as process engineering, gas separators, auxiliary systems, water-carrying supply lines etc. of an electrolysis plant, the connection to ground is insufficient on the electrolysis side (ground fault or ground loop). It is therefore important, on the one hand, to prevent current paths from being able to be closed via ground, that is to say to prevent a ground fault or ground loop from being formed. On the other hand, it is necessary to prevent, if possible, the coupling-in of electromagnetic interference fields per se or at least to reduce the interference. This problem is particularly pronounced when an electrolysis plant is directly connected to a DC current source which is provided, for instance, by a photovoltaic plant or a wind energy plant.

The disadvantageous effects of a ground loop and the coupling of alternating electromagnetic fields into the power electronic components used scale accordingly in this complex plant network consisting of a renewable energy production plant and an electrolysis plant with direct RE feeding-in of the electrolysis current for the purpose of operating the electrolysis. For example, the widespread and preferred use of insulated-gate bipolar transistors (IGBT for short) is in the rectifier supplying the electrolysis with high current. The IGBT is a semiconductor component that is used in power electronics since it combines advantages of the bipolar transistor, such as a good on-state behavior, a high reverse voltage and robustness, and the advantages of a field effect transistor by means of virtually power-free control. As a result, very accurate control of the electrolysis current with good rectification is achieved, for instance, in a so-called three-phase B6 bridge circuit with an IGBT-based rectifier. The distinctive advantages of IGBTs are the high voltage and current limits: voltages of up to 6500 V and currents of up to 3600 A with a power of up to 100 MW, which predestines IGBTs for use in electrolysis plants.

Using the invention, the circuit arrangement in an electrolysis plant provides an AC intermediate circuit which provides galvanic decoupling between an external DC source and the electrolyzer. In the AC intermediate circuit, the inverter ensures that the DC voltage from the external DC source is converted into an AC voltage which couples to the transformer on the primary side. A rectifier is connected on the secondary side of the transformer and ensures the conversion back into a DC voltage, specifically at a predetermined voltage or current level desired for the electrolysis. The circuit arrangement is therefore particularly advantageously configured as an AC intermediate circuit and is designed to provide direct current by means of an external DC source for the purpose of supplying the electrolyzer with electrolysis current. This is carried out by directly coupling or directly connecting the input to an external DC source. As the external DC source, a wind energy plant or a photovoltaic plant can advantageously be connected to the electrolysis plant and can each be advantageously configured both for offshore applications and for onshore applications in a manner independent of the grid in so-called island operation.

The external DC source can be directly and immediately connected via the input of the circuit arrangement, with the result that the electrolyzer is supplied with direct current. As a result of the galvanic isolation and decoupling via the AC intermediate circuit, the circuit arrangement is used to reliably prevent damaging interference of high-frequency stray currents and therefore ground fault currents and undesirable voltage losses in the electrolyzer. At the same time, a simple and reliable direct connection of the electrolysis plant to a renewable energy production plant can be achieved and grid-independent operation is possible. As a result of the AC intermediate circuit, particularly good and flexible adaptation to a changing voltage or current level on the power production side can be advantageously achieved.

The galvanic isolation provided by the invention should also be preferred for a further reason, in particular in alkaline electrolysis applications which are operated on the basis of alkaline electrolysis. The galvanic isolation here advantageously reduces the ground and stray currents caused by the electrolysis. The reason for this is that the ground loop cannot be closed. As a result of the galvanic isolation, the current loop is also advantageously separated by the ground.

In this case, the secondary side of the transformer is preferably not grounded in the AC intermediate circuit. This not only provides effective protection against high-frequency signal components on the connection line from the current source, but rather the DC stray currents are also noticeably reduced and suppressed since there is then a closed ground loop again.

In this case, the voltage on the input side of the AC intermediate circuit is preferably selected to be higher than required for electrolysis operation. This reduces the losses or reduces the required cross section of copper or aluminum lines, as a result of which costs are saved and even greater line distances—for example from the tower of a wind turbine with a height of approximately 100 m down to the electrolysis plant—can be overcome.

In one preferred configuration, the rectifier is controllable and/or is in the form of a three-phase rectifier, in particular a B6 bridge rectifier.

Controllability of the rectifier(s), which is/are advantageously in the form of a three-phase rectifier or a B6 bridge rectifier, makes it possible to adjust the total current produced via the rectifier(s) and therefore to control, for example, the operation of an electrolyzer connected to the circuit arrangement.

Provision is preferably made for the AC frequency to be able to be set to a predetermined value in the circuit arrangement. As a result of the configuration of the circuit arrangement as an AC intermediate circuit, it does not need to be connected to a public grid and the choice of the AC frequency in the transformer is therefore largely free. A high-frequency transformer is advantageously provided here, with the result that it is possible to deviate from the conventional frequencies in the public grids.

In a preferred configuration of the electrolysis plant, the circuit arrangement is designed for an AC frequency that is greater than the conventional grid frequencies of 50 Hz to 60 Hz in the public grids. It is appropriate here to use high frequencies since the physical size and the weight of the transformer and the use of materials can be reduced thereby. This aspect is very advantageous, in particular, when the electrolysis plant is directly connected to a wind energy plant. As a result of the more compact design and the lower weight with a high operating frequency, the transformer can be accommodated, for example, in the nacelle of the wind energy plant or in the base of the tower of the wind energy plant. The circuit arrangement overall can likewise be arranged there. The electrolysis plant can therefore be in the immediate vicinity of the wind energy plant, for example, with the result that short line paths for connection are possible.

In a particularly preferred configuration, the circuit arrangement is designed for an AC frequency of 500 Hz to 50 kHz, in particular 10 kHz to 30 kHz. This frequency relates to the frequency of the inverter and of the rectifier that are connected to the transformer. In order to exploit the installation space advantages and cost advantages, a high-frequency intermediate circuit transformer is provided as the transformer.

A transformation ratio or a voltage swing of less than 10, in particular between 1.5 and 7.5, is also preferably set in the transformer. This can be flexibly adapted to the requirements of the electrolyzer or of the desired voltage level for the electrolysis process.

The ratio of numbers of turns, or the primary-side and secondary-side voltages, is also referred to as the transformation ratio. Suitably selecting the transformation ratio, that is to say the numbers of turns, makes it possible to both step up and step down AC voltages using the transformer. This enables adaptation with respect to the electrolysis.

However, a voltage swing of greater than 10 is also possible, depending on the application and design of the electrolysis plant and specifically the transformer used. Known electrolysis plants typically operate with a maximum DC voltage of 1500 V, which still corresponds to a low-voltage range. However, a DC voltage of certainly more than 15 kV may be provided and available for connection to a power production plant. Therefore, an upper limit for the voltage swing of even up to preferably 70 may be selected. The available connection voltage—for instance if the electrolysis plant were operated at a DC voltage of only 1000 V—can then be up to approximately 70 kV. In the currently available wind energy plants, output voltages of 66 kV AC may be delivered, for example.

The voltage on the side of the power production plant is preferably greater than on the side of the electrolysis plant.

A further aspect of the invention emerges from the configuration of the electrolysis plant for preferred electrical connection of the electrolysis plant to an external DC source, wherein a renewable energy plant is directly electrically connected to the electrolysis plant. This provides an integral plant network.

In one particularly preferred configuration, the plant network comprises an electrolysis plant and a renewable energy plant having an output for providing direct current, with the result that a DC source is formed by the renewable energy plant, wherein the output is electrically connected to the input of the electrolysis plant.

This enables island grid operation that is independent of the public grid in the plant network and immediate use of power exclusively from renewable sources for the electrolysis, with the result that green hydrogen is formed.

The renewable energy plant is preferably a wind energy plant in the plant network. In this case, the wind energy plant further preferably has a rectifier that is connected to the input of the circuit arrangement on the output side or is electrically connected to the input. In this case, the rectifier converts the alternating current from the wind energy plant into a direct current and at the same time advantageously provides the desired input DC voltage level for connection to the electrolysis plant. This rectifier is also preferably designed for coordinated operation with or for suitable control of the connected generator.

In an alternative configuration, it is preferably also possible for the renewable energy plant to be a photovoltaic plant in the plant network. A PV plant already provides a direct current during operation. However, provision is preferably made for the photovoltaic plant in the plant network to have a DC chopper or DC-DC converter that is connected to the input on the output side. In this case, it is also possible for even galvanic isolation to already be provided and integrated in such a DC chopper (DC-DC converter) of a photovoltaic plant. Only a further downstream DC chopper (DC-DC converter) is then preferably needed to set the voltage for electrolysis plants and to bring it to the desired DC level for the electrolysis.

A DC-DC converter denotes an electrical circuit which converts a DC voltage supplied at the input into a DC voltage with a higher, lower or inverted voltage level. The conversion is carried out with the aid of a periodically operating electronic switch and one or more energy stores. DC-DC converters are included in the self-commutated converters. In the field of electrical energy technology, they are also referred to as DC choppers. The inductance (inductive converter) used to buffer the energy consists of a coil or a converter transformer. Known converter transformers advantageously already provide galvanic isolation, with the result that their use may be preferred in certain connection conditions and technical conditions.

Advantages and advantageous configurations of the electrolysis plant of the invention can be considered to be advantages and advantageous configurations of the plant network and vice versa.

Further advantages, features and details of the invention emerge from the following description of a preferred exemplary embodiment and on the basis of the drawing. The features and combinations of features mentioned above in the description and the features and combinations of features mentioned below in the description of the figures and/or shown in the single figures alone can be used not only in the respectively stated combination, but also in other combinations or alone, without departing from the scope of the invention.

Exemplary embodiments of the invention are explained in more detail on the basis of a drawing, in which, in a schematic and highly simplified manner:

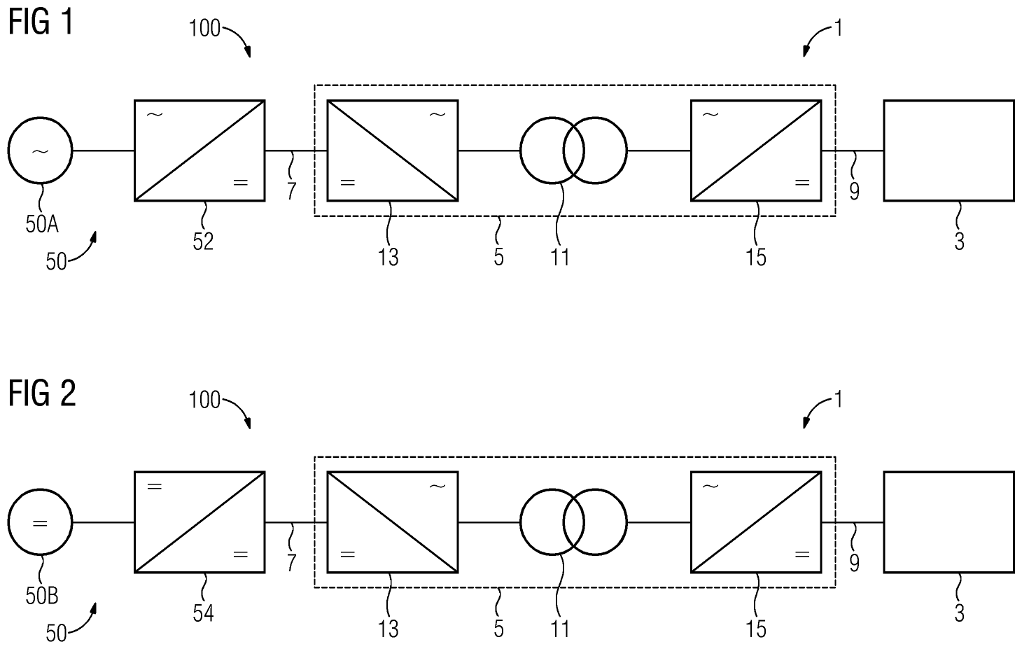

FIG. 1 shows a plant network having an electrolysis plant and a wind energy plant;

FIG. 2 shows a plant network having an electrolysis plant and a photovoltaic plant.

The same reference signs have the same meaning in the figures.

FIG. 1 illustrates a plant network 100 according to the invention. The plant network 100 comprises an electrolysis plant 1 and a wind energy plant 50A that is connected to the electrolysis plant 1 as a renewable energy plant (RE plant) and a source of green power. The electrolysis plant 1 has an electrolyzer 3 and a circuit arrangement 5 which is electrically connected to the electrolyzer 3. The circuit arrangement 5 is connected to the electrolyzer 3 via the output 9. The circuit arrangement also has an input 7 which can be used to supply a direct current to the electrolysis plant. Direct current is supplied from a DC source via the circuit arrangement 5. For this purpose, the circuit arrangement 5 has an inverter 13, a transformer 11 and a rectifier 15. The circuit arrangement 5 is therefore used to provide in the electrolysis plant an AC intermediate circuit which galvanically decouples the input 7 from the output 9. The inverter 13 is connected to the transformer 11 on the primary side. The rectifier 15 is connected to the transformer 13 on the secondary side. The electrolyzer 3 is supplied with a direct current, the electrolysis current, via the rectifier 15 of the circuit arrangement 5. The electrolyzer 3 may be in the form of a PEM electrolyzer, an AEM electrolyzer (AEM: Anion Exchange Membrane) or an alkaline electrolyzer.

In order to be supplied with direct current for the electrolysis process, the electrolysis plant 1 is directly connected to the wind energy plant 50A. Connection is effected via the input 7 of the circuit arrangement 5, which is designed to receive and forward a direct current to the inverter 13. The wind energy plant 50A initially produces an alternating current in the generator. In order to be able to transfer a direct current to the electrolysis plant 1, a rectifier 52 is provided, with the result that connection is effected via this rectifier 52, wherein the rectifier is advantageously an electrical power component of the wind energy plant 50A.

In order to vary the voltage or the current intensity for the electrolysis, the rectifier 15 is controllable and is in the form of a three-phase rectifier or a B6 bridge rectifier. This has an IGBT, an insulated gate bipolar transistor, which is not illustrated in any more detail, as a semiconductor component. This is a component which is often used in power electronics since it combines advantages of the bipolar transistor, such as a good on-state behavior, a high reverse voltage and robustness, and the advantages of a field effect transistor with virtually power-free control. The distinctive advantages of IGBTs are the high voltage and current limits with operating voltages of up to 6500 V and currents of up to 3600 A with a power of up to 100 MW. As a result, the IGBT in the rectifier 15 can be ideally used for the operating range of the electrolyzer 3. Depending on the application, it is also conceivable to use a so-called IGCT, that is to say an integrated gate-commutated thyristor. The latter has a reduced wiring complexity, an increase in the maximum pulse frequencies for control and better switching times when connected in series, which is advantageous. The field of use of IGCTs are high-power converters. An individual module typically switches several kiloamperes at a typical reverse voltage of 4500 V.

In the circuit arrangement 5, the AC frequency of the transformer 11 can be flexibly set to a predetermined value. In the example, the circuit arrangement 5 is designed for an AC frequency that is greater than the conventional grid frequencies of 50-60 Hz of public grids, which is advantageous. AC frequencies of 500 Hz to 50 kHz, in particular 10 kHz to 30 kHz, can be set, with the result that the transformer 11 acts as a high-frequency intermediate circuit transformer. Considerable installation space advantages arise for the transformer 15 in this frequency range, with the result that a considerably more compact design with less use of material is possible in comparison with grid transformers.

In this case, a transformation ratio of less than 10, in particular between 1.5 and 7.5, is set in the transformer 11 for the voltage level on the secondary side with respect to the primary side. However, transformation ratios of greater than 10 and up to 70 are possible. The circuit arrangement 5 provides galvanic decoupling via a DC intermediate circuit. In this case, the transformer 11 is preferably not grounded at the primary-side neutral point. In addition, grounding of the transformer 11 at the secondary-side neutral point is also preferably not provided. This prevents high-frequency electrical stray currents during operation which can be coupled in via ground loops and adversely affect the electrolyzer 3 with the very sensitive electrolysis cells since the ohmic losses caused by ground loops can result in a very disadvantageous voltage drop across the electrolysis cells.

All other stray currents to ground in the region of the electrolysis itself, in particular also the 0 Hz DC stray currents, are also avoided. This reduces, in particular, corrosion in the so-called process technology and in the sensitive auxiliary systems of the electrolysis plant 1 and increases the service life of the electrolysis modules and electrolysis cells.

The lower the electrical resistance of the ground connection between the components involved, the lower the potential difference and the interference current. This is conventionally achieved by means of low-resistance cable and plug-in connections or a large cross section of the shields, a lower contact transition resistance and the advantageous galvanic decoupling described here.

During operation of the plant network 100, green power is produced in the wind energy plant 50A. The alternating current produced in the generator is converted into a direct current in the rectifier 52. As a result, the renewable energy plant 50—using the example of the wind energy plant 50A—provides a DC source, with the result that a direct current is directly fed into the input 7 of the electrolysis plant 1 via an output of the rectifier 52 and is initially transferred to the circuit arrangement 5. In the circuit arrangement 5, the circuits are galvanically isolated by the transformer 11, with the result that stray currents are suppressed or avoided. Conversion into an AC voltage first of all takes place on the primary side of transformer 11. The transformer 11 transforms this AC voltage, on the secondary side, to a desired voltage level corresponding to the transformation ratio that has been set. The rectifier 15 provides an interference-free or hum-free electrolysis DC voltage at the output 7 on the output side, which DC voltage is used to stably operate the electrolyzer 3, wherein water is broken down into hydrogen and oxygen. Ground loops are avoided. The advantageous direct DC connection of the electrolysis plant 1 to the wind energy plant 52A enables grid-independent island operation and decentralized production of green power onshore or offshore depending on the application. The proportion of green hydrogen is 100%.

In a further exemplary embodiment of a plant network 100 according to the invention, FIG. 2 shows an alternative DC source for supplying the electrolysis plant 1 with direct current. In this case, the renewable energy plant 50 has a photovoltaic plant 50B having a multiplicity of PV modules which are not illustrated in any more detail. The photovoltaic plant 50B may be, for example, in the form of an extensive and powerful open-field plant—preferably in sunny regions—with the result that PV powers of 10 MW of electrical power are available for the electrolysis. A completely similar plant concept to that in FIG. 1 is used on the side of the electrolysis plant 1, as are corresponding plant components, that is to say with a circuit arrangement 5 and an electrolyzer 3.

In order to arrive at a desired and advantageous voltage level for the connection to the electrolysis plant 1, a DC chopper 54 is connected to the photovoltaic plant 50B in the example in FIG. 2. A DC chopper 54 is also referred to as a DC-DC converter, with the result that the DC voltage supplied at its input from the photovoltaic plant 50B is converted into a DC voltage with a higher, lower or inverted voltage level. Conversion is effected with the aid of a periodically operating electronic switch and one or more energy stores. DC choppers 54, also referred to as DC-DC converters, are included in the self-commutated converters which play a major role in the field of electrical energy technology. The inductance (inductive converter) used to buffer the energy consists of a coil or a converter transformer. Galvanic isolation is already achieved by virtue of a configuration as a converter transformer.

The DC chopper 54 connected to the photovoltaic plant 50B is connected, on the output side, to the input 7 of the circuit arrangement 5, thus achieving direct connection to the electrolysis plant 1 and supply with PV direct current, wherein the stray currents are effectively suppressed by the galvanic decoupling.

The invention is used to specify an electrolysis plant 1 which can be used to feed a direct current from a renewable source into the electrolysis plant 1 directly and without interference, with the result that 100% green hydrogen can be produced in the electrolysis. This is carried out in a particularly advantageous manner in the described plant network 100 comprising an electrolysis plant 1 and a renewable energy plant 50, which are directly electrically connected to one another.

1-13. (canceled).

14. An electrolysis plant, comprising:
an electrolyzer;
a circuit arrangement having an input for connection to an external DC source and an output connected to said electrolyzer;
said circuit arrangement including a transformer having a primary side and a secondary side, an inverter connected on said primary side and a rectifier connected on said secondary side, and enabling a direct current to be supplied to said electrolyzer.

15. The electrolysis plant according to claim 14, wherein said rectifier is at least one of a controllable rectifier or a three-phase rectifier.

16. The electrolysis plant according to claim 15, wherein said rectifier is a B6 bridge rectifier.

17. The electrolysis plant according to claim 14, wherein said circuit arrangement is configured for an AC frequency thereof to be set to a predetermined value.

18. The electrolysis plant according to claim 14, wherein said circuit arrangement is designed for an AC frequency that is greater than a grid frequency in a range of 50-60 Hz.

19. The electrolysis plant according to claim 14, wherein said circuit arrangement is designed for an AC frequency of 500 Hz to 50 KHz.

20. The electrolysis plant according to claim 19, wherein said circuit arrangement is designed for an AC frequency of 10 KHz to 30 KHz.

21. The electrolysis plant according to claim 14, wherein said transformer has a transformation ratio of less than 10.

22. The electrolysis plant according to claim 21, wherein the transformation ratio of said transformer lies between 1.5 and 7.5.

23. The electrolysis plant according to claim 14, wherein said transformer has a primary-side neutral point that is not grounded.

24. The electrolysis plant according to claim 23, wherein said transformer has a secondary-side neutral point that is not grounded.

25. The electrolysis plant according to claim 14, wherein said transformer has a secondary-side neutral point that is not grounded.

26. A plant network, comprising:
an electrolysis plant according to claim 14; and
a renewable energy plant having an output for providing a direct current, said renewable energy plant having an output forming the DC source connected to the input of the circuit arrangement of said electrolysis plant.

27. The plant network according to claim 26, wherein said renewable energy plant comprises a wind energy plant.

28. The plant network according to claim 27, wherein said wind energy plant includes a rectifier with an output connected to said input of the circuit arrangement of said electrolysis plant.

29. The plant network according to claim 26, wherein said renewable energy plant comprises a photovoltaic plant.

30. The plant network according to claim 29, wherein said photovoltaic plant includes a DC chopper with an output connected to said input of the circuit arrangement of said electrolysis plant.
